(19) United States
(12) Patent Application Publication
(10) Pub. No.: US 2009/0241330 A1
(43) Pub. Date: Oct. 1, 2009

(54) BEARING ASSEMBLY TOOL FOR USE IN A BICYCLE

(76) Inventor: Ming-Te WANG, Nantou City (TW)

Correspondence Address: Dr. BANGER SHIA;Int''l Patent Office of Bang Shia, 102 Lindencrest Ct, Sugar Land, TX, 77479-5201, US

(21) Appl. No.: 12/205,855

(22) Filed: Sep. 6, 2008

(30) Foreign Application Priority Data
Apr. 1, 2008 (TW) 097200280

(51) Int. Cl. B23P 19/00

(52) U.S. Cl. 29/802

(57) ABSTRACT

A bearing assembly tool for use in a bicycle comprises a contacting member, a handle, an engaging member, a screw, a press member, and a limiting member. By way of the screw, the contacting member and the engaging member, or the press member and the limiting member, a bearing can be assembled into or removed from a workpiece.

### BACKGROUND OF THE INVENTION

1. Field of the Invention

The present invention relates to a tool for use in a bicycle, and more particularly to a tool that can be used to assemble/remove a bearing into/from the bicycle.

2. Description of the Prior Art

Conventionally, the bearing is assembled into the predetermined position of the bicycle by using a hammer. However, the rolling balls disposed in the bearing will be damaged as the hammer hits the bearing. Besides, as desiring to remove the bearing, a flat screwdriver is inserted into the gap between the bearing and the predetermined position of the bicycle to remove the bearing, causing damage of the predetermined position and the flat screwdriver.

The present invention has arisen to mitigate and/or obviate the afore-described disadvantages.

### SUMMARY OF THE INVENTION

The primary objective of the present invention is to provide a bearing assembly tool for use in a bicycle that can be used in a narrow space and portable easily.

Another objective of the present invention is to provide a bearing assembly tool for use in a bicycle that while removing the bearing from the workpiece, the contacting member and the engaging member can be screwed with the screw, and they can also be turned backward and then used to assemble the bearing into the workpiece.

To achieve the above-mentioned objectives, the bearing assembly tool for use in a bicycle provided in accordance with the present invention comprises:

a contacting member including a push post, between the push post and the contacting member being defined with a first through screw hole for screwing a screw therein, and the contacting member including a handle disposed on one side thereof for being held;

the screw including a screw head having a driving portion fixed therein for fitting and driving a tool, another end of the screw allowing to screw with the first screw hole of the push post or with a third screw hole of a limiting member, the screw can be inserted into a through aperture of an engaging member or into a through bore of a press member;

the engaging member including a first side surface and a second side surface between which is defined with a through aperture, the first side surface allowing to be used to abut against the screw head of the screw, and the second side surface including a receiving groove for receiving a bearing, the receiving groove including an abutting portion arranged on the extended rib of the outer wall thereof for contacting with the workpiece.

While removing the bearing from the workpiece, the screw is inserted through the engaging member so that the engaging member is fixed on one surface of the workpiece and the contacting member is disposed on another surface of the workpiece, and the push post is inserted into the opening of the workpiece. Thereafter, the tool is inserted into the driving portion of the screw and is further rotated to urge the screw to screw into the push post. As the end surface of the push post is biased against the bearing and the screw is further screwed into the first screw hole, the push post pushes the bearing to move from the workpiece into the receiving groove, thus removing the bearing from the workpiece.

As desiring to assemble the bearing into the workpiece, the contacting member will be replaced by the limiting member, and the engaging member will be replaced by the press member, wherein the press member is provided with two side surfaces between which is defined with the through bore, one side surface of the press member is used to contact with the screw head of the screw, and another side surface thereof is applied to abut against the bearing, the limiting member is provided with the third screw hole for screwing the screw therein. Furthermore, the limiting member includes a limit portion mounted on one side thereof so that the limiting member can be disposed to the opening in the corner of the workpiece by using the limit portion.

The limiting member and the press member are fixed on the opposite sides of the workpiece respectively, and the screw is in turn inserted through the press member and the bearing, the press member is mounted on one surface of the workpiece where the bearing is fixed, and the limiting member is secured to another surface of the workpiece, hence the screw can be inserted through the opening of the workpiece, and then the tool is fitted into the driving portion for being rotated to drive the screw to screw into the limiting member. Thereafter, the screw head of the screw abuts against the press member for indirectly pushing the bearing into the predetermined position of the workpiece, thereby assembling the bearing into the workpiece.

As the contacting member and the engaging member are turned backward and then used to assemble the bear into the workpiece, the screw head of the screw contacts with the bottom surface of the receiving groove, and the first side surface biases against the bearing, the screw is inserted through the opening of the workpiece, and the tool is inserted into the driving portion and then rotated so that the screw is driven to screw into the first screw hole of the contacting member, such that the screw head of the screw abuts against the engaging member to indirectly push the bearing into the predetermined position of the workpiece, assembling the bearing into the workpiece.

### BRIEF DESCRIPTION OF THE DRAWINGS

FIG. 1 is a perspective view illustrating the exploded components of a bearing assembly tool for use in a bicycle according to the present invention;

FIG. 2 is a cross sectional view illustrating the exploded components of the bearing assembly tool for use in the bicycle according to the present invention;

FIG. 3 is a cross sectional view illustrating a bearing being removed from a workpiece according to the present invention;

FIG. 4 is another cross sectional view illustrating the bearing being removed from the workpiece according to the present invention;

FIG. 5 is a perspective view illustrating the exploded components of the bearing assembly tool for use in assembling the bearing into the workpiece of the bicycle according to the present invention;

FIG. 6 is a cross sectional view illustrating the exploded components of the bearing assembly tool for use in assembling the bearing into the workpiece of the bicycle according to the present invention;

FIG. 7 is a cross sectional view illustrating a limiting member and a press member being used to assemble the bearing into the workpiece according to the present invention;

FIG. 8 is a cross sectional view illustrating a contacting member and an engaging member being turned backward and then used to assemble the bearing into the workpiece according to the present invention.

### DETAILED DESCRIPTION OF THE PREFERRED EMBODIMENT

The present invention will be clearer from the following description when viewed together with the accompanying drawings, which show, for purpose of illustrations only, the preferred embodiment in accordance with the present invention.

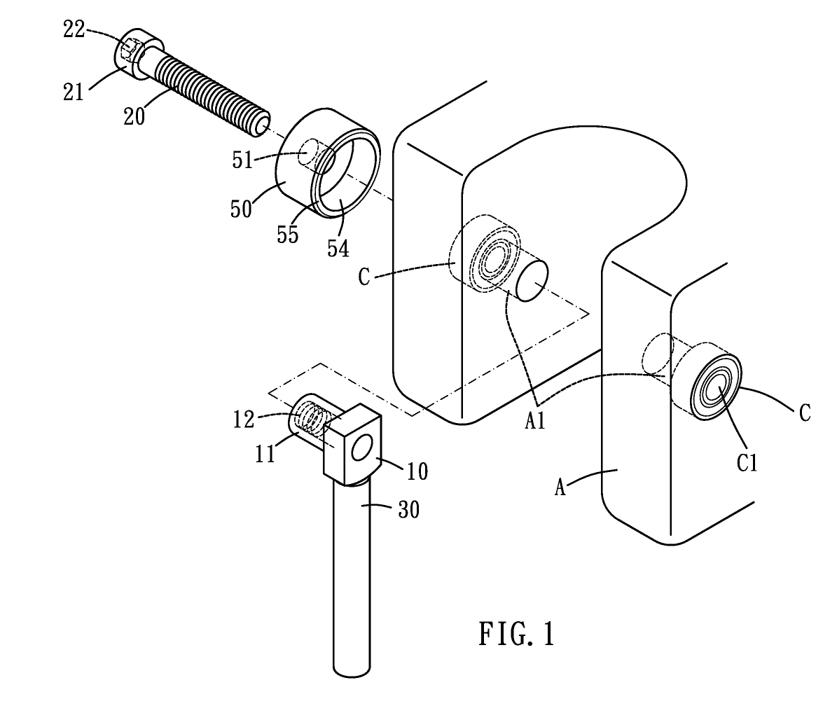

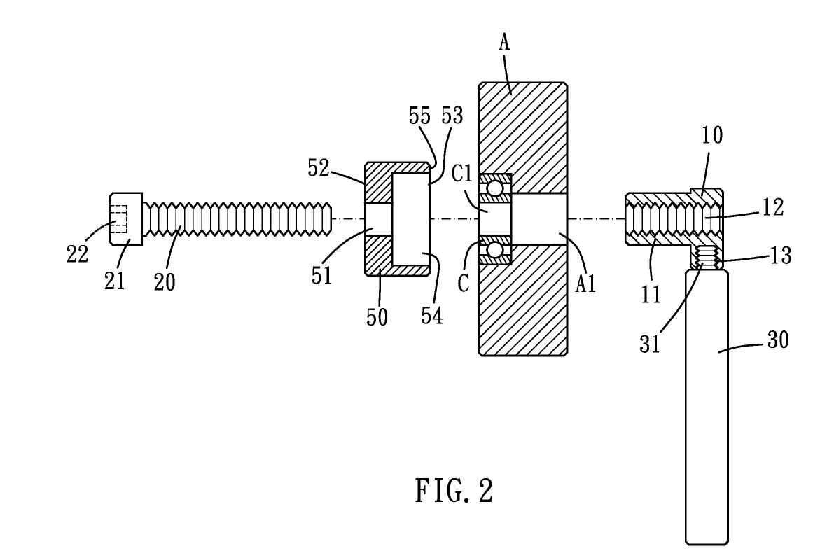

Referring to FIGS. 1-5, a bearing assembly tool for use in a bicycle in accordance with the present invention comprises a contacting member 10, the contacting member 10 being a pieced structure and including a push post 11 extended from one surface thereof, between the push post 11 and the contacting member 10 being defined with a first through screw hole 12 for screwing a screw 20 therein, and the push post 11 allowing to be received in an opening A1 of a workpiece A, on one side of the contacting member 10 being formed a second screw hole 13 for screwing a screwing portion 31 of a handle 30 therein so that the handle 30 can be held by a user and can be used to extend the length of the contacting member 10. For example, as using the bearing assembly tool in a narrow space, the handle 30 can be inserted therein easily. The screw 20 includes an enlarged screw head 21 disposed on one end thereof, and the screw head 21 includes a driving portion 22 fixed therein for fitting and driving a tool B, another end of the screw 20 allows to screw with the first through screw hole 12 of the push post 11 or with a third screw hole 41 of a limiting member 40. Furthermore, the screw 20 can be inserted into a through aperture 51 of an engaging member 50 or into a through bore 61 of a press member 60.

The engaging member 50 includes a first side surface 52 and a second side surface 53 between which is defined with the through aperture 51 for inserting the screw 20 therein. The first side surface 52 allows to be used to abut against the screw head 21 of the screw 20, and the second side surface 53 includes a receiving groove 54 formed therein for receiving a bearing C as the bearing B is assembled into or removed from the workpiece A. The receiving groove 54 includes an abutting portion 55 arranged on the extended rib of the outer wall thereof for contacting with the workpiece A.

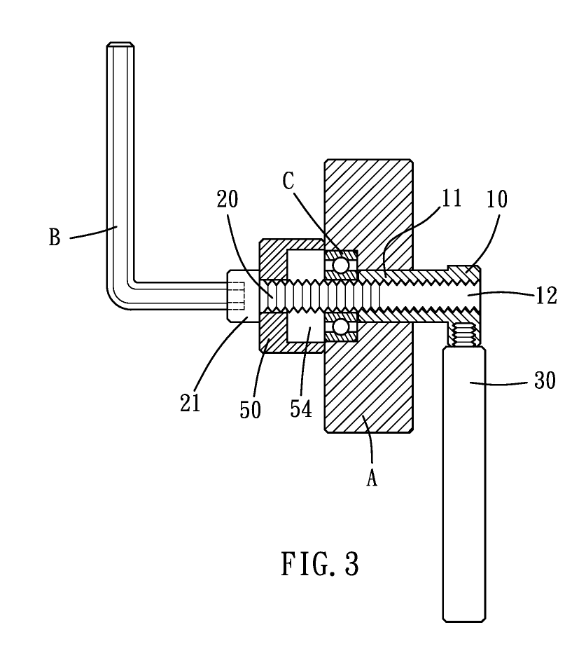

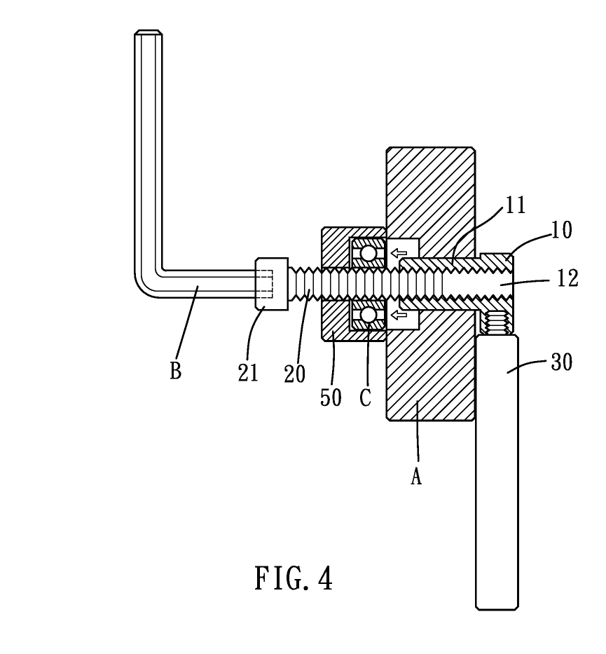

As shown in FIGS. 3 and 4, while removing the bearing C from the workpiece A, the screw 20 is inserted through the through aperture 51 of the engaging member 50 so that the engaging member 50 is fixed on one surface of the workpiece A and the contacting member 10 is disposed on another surface of the workpiece A, and the push post 11 is inserted into the opening A1 of the workpiece A. Thereafter, the tool B is inserted into the driving portion 22 of the screw 20 and the screw 20 is inserted through a central orifice C1 of the bearing C, the tool B is further rotated to urge the screw 20 to screw into the first screw hole 12 of the push post 11. As the user holds the handle 30 of the contacting member 10 by his hand, the contacting member 10 can be prevented from rotation with the screw 20. Besides, the extended length of the handle 30 can be used in an elongated narrow space. As the end surface of the push post 11 is biased against the bearing C and the screw 20 is further screwed into the first screw hole 12, the push post 11 slowly pushes the bearing C to move from the workpiece A into the receiving groove 54 of the engaging member 50. As the bearing C is pushed to move into the receiving groove 54 completely, the screw 20 is rotated to move away from the first screw hole 12 in opposite direction, thus removing the bearing C from the workpiece A.

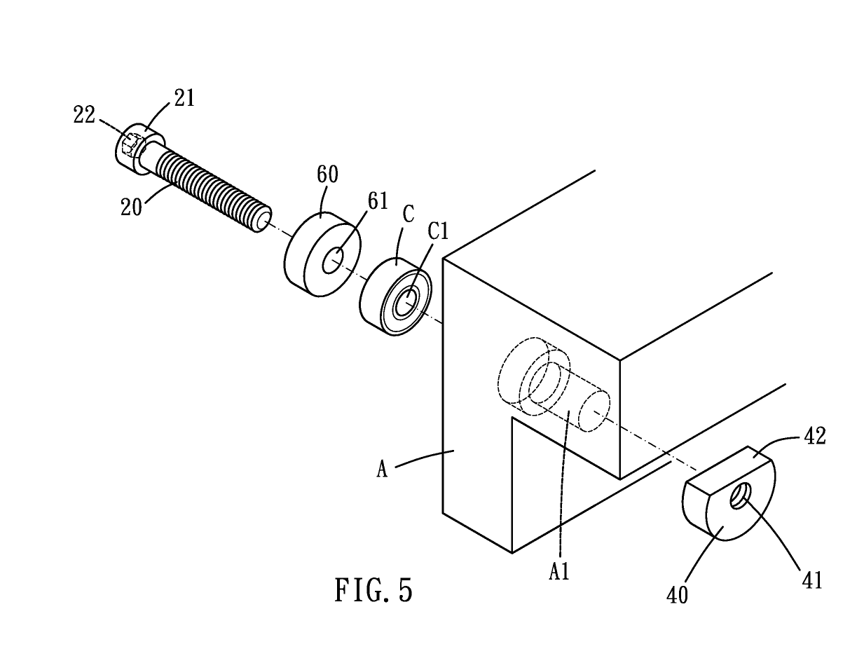

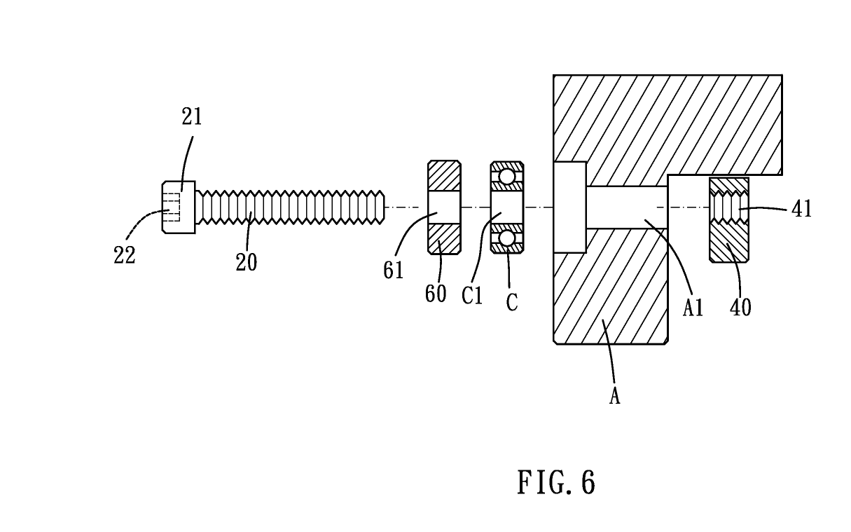

Referring further to FIGS. 5-7, as desiring to assemble the bearing C into the workpiece A, the contacting member 10 will be replaced by the limiting member 40, and the engaging member 50 will be replaced by the press member 60, wherein the press member 60 is provided with two side surfaces between which is defined with the through bore 61 for inserting the screw 20 therein, one side surface of the press member 60 is used to contact with the screw head 21 of the screw 20, and another side surface thereof is applied to abut against the surface of the bearing C, the limiting member 40 is provided with the third screw hole 41 for screwing the screw 20 therein. Furthermore, the limiting member 40 includes a cross sectional limit portion 42 mounted on one side thereof so that while the opening A1 is disposed in the corner of the workpiece A, the limit portion 42 allows to press against the side wall of the workpiece A, therefore the limiting member 40 will not be rotated with the screw 20.

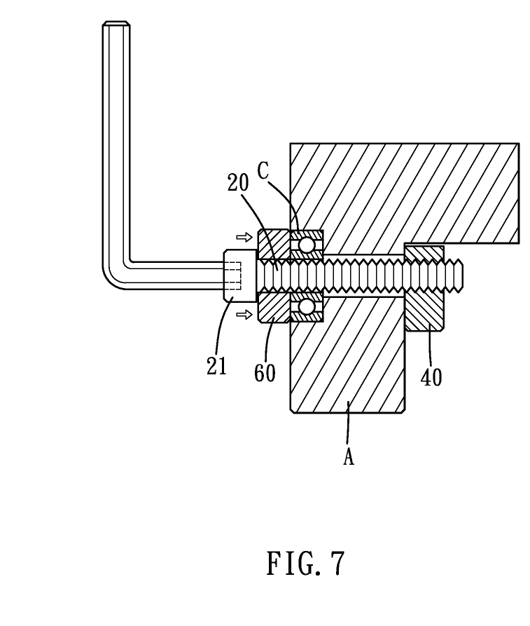

The limiting member 40 and the press member 60 are fixed on the opposite sides of the workpiece A respectively, and the screw 20 is in turn inserted through the through bore 61 of the press member 60 and the central orifice C1 of the bearing C, the press member 60 is mounted on one surface of the workpiece A where the bearing C is fixed, and the limiting member 40 is secured to another surface of the workpiece A, hence the screw 20 can be inserted through the opening Al of the workpiece A as shown in FIG. 7, and then the tool B is fitted into the driving portion 22 for being rotated to drive the screw 20 to screw into the third screw hole 41 of the limiting member 40. Thereafter, the screw head 21 of the screw 20 abuts against the press member 60 for indirectly pushing the bearing C into the predetermined position of the workpiece A, and then the screw 20 is rotated to move away from the third screw hole 41 in opposite direction, thereby assembling the bearing C into the workpiece A.

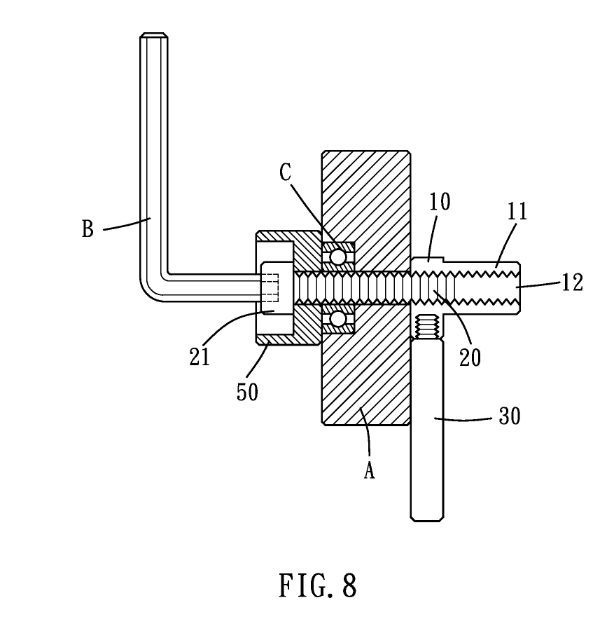

With reference to FIG. 8, as the contacting member 10 and the engaging member 50 are turned backward and then used to assemble the bearing C into the workpiece A, the screw head 21 of the screw 20 contacts with the bottom surface of the receiving groove 54, and the first side surface 52 biases against the bearing C which is fitted into the screw 20, the screw 20 is inserted through the opening A1 of the workpiece A, and the tool B is inserted into the driving portion 22 and then rotated so that the screw 20 is driven to screw into the first screw hole 12 of the contacting member 10, such that the screw head 21 of the screw 20 abuts against the engaging member 50 to indirectly push the bearing C into the predetermined position of the workpiece A, assembling the bearing C into the workpiece A.

While we have shown and described various embodiments in accordance with the present invention, it is clear to those skilled in the art that further embodiments may be made without departing from the scope of the present invention.

What is claimed is:

1. A bearing assembly tool for use in a bicycle comprising:
a contacting member, the contacting member being a pieced structure and including a push post extended from one surface thereof, between the push post and the contacting member being defined with a first through screw hole, and the push post allowing to be received in an opening of a workpiece, on one side of the contacting member opposite to the first screw hole being formed a second screw hole;
a handle, at one end of which is provided with a screwing portion so as to be screwed with the first screw hole of the contacting member, and another end of the handle serving to be held;
a screw including an enlarged screw head disposed on one end thereof, and the screw head including a driving portion fixed therein for fitting and driving a tool, the screw allowing to screw with the first screw hole of the push post;
an engaging member including a first side surface and a second side surface between which is defined with a through aperture for inserting the screw therein, the first side surface allowing to be used to abut against the screw head of the screw, and the second side surface including a receiving groove formed therein for receiving a bearing as assembling/removing the bearing into/from the workpiece, the receiving groove including an abutting portion arranged on the extended rib of the outer wall thereof for contacting with the workpiece as assembling/removing the bearing into/from the workpiece, wherein the contacting member and the engaging member are fixed on the opposite side surfaces of the workpiece while in use;
a press member being provided with two side surfaces between which is defined with a through bore for inserting the screw therein, wherein one side surface of the press member is used to contact with the screw head of the screw, and another side surface thereof is applied to abut against the surface of the bearing; and
a limiting member being provided with a third screw hole for screwing the screw therein, and the limiting member and the press member are fixed on the opposite side surfaces of the workpiece while in use.

2. The bearing assembly tool for use in the bicycle as claimed in claim 1, wherein the limiting member includes a limit portion mounted on one side thereof.

3. The bearing assembly tool for use in the bicycle as claimed in claim 2, wherein the limit portion is formed in a cross sectional shape.

4. The bearing assembly tool for use in the bicycle as claimed in claim 1, wherein as the screw is screwed into the first screw hole of the contacting member, the engaging member is disposed between the screw and the contacting member.

5. The bearing assembly tool for use in the bicycle as claimed in claim 1, wherein as the screw is screwed into the third screw hole of the limiting member, the press member is mounted between the screw and the limiting member.

6. A bearing assembly tool for use in a bicycle comprising:
a contacting member, the contacting member being a pieced structure and including a push post extended from one surface thereof, between the push post and the contacting member being defined with a first through screw hole, and the push post allowing to be received in an opening of a workpiece, on one side of the contacting member opposite to the first screw hole being formed a second screw hole;
a handle, at one end of which is provided with a screwing portion so as to be screwed with the first screw hole of the contacting member, and another end of the handle serving to be held;
a screw including an enlarged screw head disposed on one end thereof, and the screw head including a driving portion fixed therein for fitting and driving a tool, the screw allowing to screw with the first screw hole of the push post;
an engaging member including a first side surface and a second side surface between which is defined with a through aperture for inserting the screw therein, the first side surface allowing to be used to abut against the screw head of the screw, and the second side surface including a receiving groove formed therein for receiving a bearing as assembling/removing the bearing into/from the workpiece, the receiving groove including an abutting portion arranged on the extended rib of the outer wall thereof for contacting with the workpiece as assembling/removing the bearing into/from the workpiece, wherein the contacting member and the engaging member are fixed on the opposite side surfaces of the workpiece while in use.

7. The bearing assembly tool for use in the bicycle as claimed in claim 6, wherein the contacting member includes the handle disposed on one side thereof.

8. The bearing assembly tool for use in the bicycle as claimed in claim 6, wherein as the screw is screwed into the first screw hole of the contacting member, the engaging member is disposed between the screw and the contacting member.
